(19) United States
(12) Patent Application Publication
(10) Pub. No.: US 2016/0336681 A1
(43) Pub. Date: Nov. 17, 2016

(54) Protective Cover for Electrical Plug and Socket Connection

(71) Applicant: Arthur Tutela, West Orange, NJ (US)

(72) Inventor: Arthur Tutela, West Orange, NJ (US)

(21) Appl. No.: 14/713,299

(22) Filed: May 15, 2015

(51) Int. Cl. H01R 13/52

(52) U.S. Cl. CPC H01R 13/5213

(57) ABSTRACT

A protective sleeve for electrical wires and their mechanical and electrical, male plug to female socket, connection. The cylindrical sleeve comprises an adhesive interior, securing end ties on each of the lateral openings of the sleeve, and a protective, removable film over the adhesive interior. The sleeve is waterproof. The adhesive surface covers the interior of the sleeve. The adhesive is preserved until desirably activated by a disposable covering film that has a pull tab for easy removal. The end ties, drawstrings or elastic, are held in fold-over end pockets at the two side openings of the sleeve. Tightening the end ties secures the sleeve on the electrical cords and their connection. A double sealed connection (adhesive sleeve and its cinched ends) is provided.

### FIELD OF THE INVENTION

The present invention relates generally to the field of protecting the male to female plug and socket connection of electrical wiring. Specifically, the present invention is primarily intended for use as a protective sleeve for the connection of electrical wires in an outdoor residential environment. Basically, the sleeve comprises a waterproof or water resistant circular tube with open ends sized to allow the connecting ends to initially pass therethrough with the extending wires from the plug and socket of different wires able to extend out of the tubular housing. The interior of the tubular sleeve is coated either entirely or at least partially with an adhesive coating for adhering and sealing the interior of the sleeve to one or both of the extending wires and/or the plug and socket/receptacle of the connected wires. The adhesive coating is preferably initially covered with a thin frangible film to preserve the adhesive prior to use. Each end of the tubular sleeve is provided with a closing means for closing the otherwise open ends, such as by a drawstring or a tie, to further protect the electrical wires and the plug/socket connection when the same are within the tubular protective sleeve. .

### BACKGROUND OF THE INVENTION

Electrical cords are used to carry electricity from an electrical source to a powered device via an electrical wire or conductive material covered in a protective, insulated coating. Electrical cords have become indispensable in today's world. One of the most common application of these cords is outdoor use to power lighting and machines, among other devices. These cords are capable of handling up to 220-440 volts in certain applications, and therefore require careful safety precautions. Outdoor applications in particular run the risk of exposing these high voltage carrying lines to water. Electrical shorting and/or shocks can result. Also, the wires, when their connections are exposed and come into contact with water, can transfer the electrical current to outdoor debris which may easily catch fire. Outdoor extension cords and other cord connection points are especially dangerous as the insulated coating is interrupted at the connection point—the plug or receptical/socket. This interruption can cause the electrical current to be exposed to the elements, possibly causing damage that might lead to a disruption in the electrical system, sparking and fires, and even electrocution.

Numerous housings have been devised to prevent inadvertent exposure of electrical wires and cords and their connections to one another. However, housings currently on the market involve simple coverings that are prone to tears and leaks. This flaw renders the current options useless after a rough storm, animal interference, or material failure as breaks in the devices can leave the electrical wires or their connection points exposed. It is thus considered highly advantageous to provide a protective covering for electrical wires and their socket connections that will remain water resistant in spite of tears or leaks in the material. The present invention is a protective covering for electrical wires at the point of their connections. Preferably, the present invention provides a tubular flexible housing through which the wires and their plug attachment and socket extends with the interior of the tubular housing being sticky so that the same adheres to the wires/cords and/or the connection points, creating a longitudinally wide and somewhat impenetrable seal. This will protect against shorting and electrical issues which occur due to rain, water and moisture coming into contact with the exposed wires and connections.

### DESCRIPTION OF PRIOR ART

There are hard, inflexible electrical connection covers with snap housings. A user would insert each of the opposed ends of a pair of electrical wires and connections into the housing, connect the same (male plue to female receptacle) and then snap the housing shut. These do not offer the protection afforded by the present invention. To the Applicant's knowledge, no prior art electrical cord or plug/socket protective case or cover combines the structural features and functionality of a cylindrical flexible sleeve, with an adhesive interior to come into contact with the wires and/or the electrical connections, and also having opposed end ties which provide a second seal to the interior of the protective sleeve. Thus, it is considered advantageous to provide an electrical cord and plug/socket sleeve-like cover which contains all of these components for the purpose of reducing the risk of exposure of electrical current to individuals, and to the elements.

### SUMMARY OF THE INVENTION

The present invention comprises a water-resistant tubular, open ended, flexible sleeve for protecting and reinforcing wire cords and their electrical connections. The water-resistant sleeve is an open cylindrical shape with an adhesive interior and securing ties, preferably drawstrings, on each end. The sleeve is made of water-resistant material such as plastic or nylon. The adhesive surface can be made of any known and preferred sticky material and may cover the entire interior of the sleeve or it may only cover an essential segment (like the middle, near to where the electrical connection between plug and socket end of the connecting wires). The adhesive is preferably protected by a breakable or disposable thin film prior to use that preferably has a pull tab for easy removal of the film covering thereby exposing the underlying adhesive layer. Alternatively, the protective film overlying the adhesive layer can break by manual manipulation like that which occurs with frangible items, e.g., night like sticks, cold paks, and/or refrigerated cookie dough in a cylinder form. End ties are preferably provided on the ends of the tubular string which connect to drawstrings that are housed in seams located on the distal circular edges of the sleeve with excess string of the drawstring extending beyond the outer wall of the sleeve for easy access and selective gripping for tightening. Tightening the end ties will further secure (in addition to the interior adhesive of the sleeve) the invention in place on the electrical cords and their plug and socket connection. The device is intended to protect the wiring of the cords, most particularly the electrical connection or joint between two wires, i.e., the male plug and its corresponding female socket/receptacle, from exposure to water, debris, and other elements and therefore maximizes consumer safety in outside use.

The invention is used by first threading the cylindrical sleeve on one end of a first length of wire. Then the other end of the sleeve is slid over the end of the other wire. The two wires, male plug to female socket or receptacle are are then joined. The inside adhesive layer is then “activated” by either breaking the frangible seal of the same or by pulling on a tab to expose the adhesive layer, i.e., by pulling off or removing the protective film. The user then manually squeezes the adhesive layer on the inside of the tubular sleeve about the interiorly located plug to socket connection. The sleeve is thus held in relative longitudinal location. Then, the ends of the tubular sleeve are closed off, around the wiring extending therethrough, by pulling the drawstrings at the opposed opendings until the openings of the sleeve encircle the wires extending outwardly therethrough. A double sealed protective device for electrical connection is thus provided, small in dimensions, substantially the same as the electrical connection itself, formed by the interior adhesive of the sleeve being against the connection and further by the circular ends of the sleeve pulled tightly around outside of the wires. Stated differently for ease of understanding and completeness, once the connecting ends of the two wires to be connected are close to one another, the sleeve is slid over one end and then the other end; the wires within the sleeve being capable of easy manipulation (the sleeve is flexible) to join the plug of one wire to the socket of the other wire. Then, the protective film is removed and the adhesive, now exposed layer is squeezed onto or joined to the wires and the connection joing by manual pressure. Finally, the end ties (the drawstrings at the open ends of the sleeve) are pulled and tightened. A double sealed and positively located, protective device results. It is crushable so that its outside dimensions are substantially that of the wires and the electrical plug and socket housed therein.

### BRIEF DESCRIPTION OF THE DRAWINGS

FIG. 1 is a cross-sectional view of the invention in place covering the electrical connection point of two cords of wire, showing male plug into female socket, before the adhesive lining is exposed and before the end openings pulled against the outside circumference of the wires.

### DETAILED DESCRIPTION OF THE PREFERRED EMBODIMENT OF THE INVENTION AND THE FIGURE

The invention relates to a protective covering for electrical wires or extension cords and the electrical connections for the same. The invention consists of a cylindrical sleeve with circular end openings. Preferably an interior adhesive layer is provided to the sleeve and the otherwise open ends are provided with one or more drawstring or end ties for holding enclosing the ends around the circumference of the wire. The invention may be used to cover and protect an electrical connection point (male plug 10 of a first wire 8 to the female socket or receptacle 12 of a second wire 14). The wires can be either extension cords for outdoor use or a component of a device or machine which is connected to a plug of an extension cord, e.g., leaf blowers, electrical starter for a snow thrower, etc. The device 9 is intended to protect the wires, their connections 10 and 12, and the interface where the male plug 10 connects into the female socket or receptacle 12.

The sleeve 15 is basically cylindrical in shape with an outer flexible or material-like surface and a longitudinal hollow interior. The sleeve in cross section may be provided as a circle (preferred), square or rectangle or any other shape. But, it should be appreciated that it is centrally hollow along its longitudinal axis. In effect it forms a collapsible tube. The inside diameter of the tube must be sufficient to surround the outside diameter of the wiring and the connection between the plug 10 and socket 12. The sleeve 15 is water resistant and can be made of any water resistant material known and preferred by the manufacturer, however materials such as plastics, nylon, tight woven threads, or natural fibers are preferred. Preferably, the sleeve is crushible or flexible, like the sleeve of a cotton T-shirt, although some strength can be provided so that it retains its original shape until it is positively crushed or collapsed to a smaller diameter, when used.

In the preferred embodiment the invention may be discarded after each use and thus the material should be inexpensive and easily removable from the wires and connection. In preferred embodiments, the sleeve 10 is tear resistant as well. The sleeve 10 can be of any diameter and length as is required to fit the given electrical cords and their connecting ends. As such the invention maybe used on any type or size of wires or cords 14, whether they be in commercial or residential settings, outdoors or indoors.

The interior surface 12 of the sleeve is covered, at least in part, preferably over the middle and outwardly towards the ends, with an adhesive layer 13, such as glue or other known sticky material. Pressure sensitive adhesives are preferred. In some embodiments, the adhesive is in the middle of the inside of the cylinder but extending laterally outwardly so as to at least in part cover some of the wiring i.e., the adhesive should extend beyond the connection area of the middle of the inside cylinder. In an alternate embodiment, the adhesive may only be in the middle inside of the cylinder to come into contact, when activated or exposed, with the male plug and female receptacle connection. In yet another embodiment, the inside of the cylinder is substantially completely coated with adhesive so that the connection area (male plug to female receptacle) and a substantial length of the laterally extending wires within the cylinder come into contact with the adhesive. The adhesive, it will be appreciated, will positively locate the cylinder and maintain the same in place until removed by manual sliding and/or by use of a cutting scissors or a rip tear to the cylinder, extending along at least a part of its length.

The adhesive layer 13 is itself covered with a thin protective layer 15. Removal or breaking of this layer will expose and/or activate the adhesive. The protective layer 15, on the inside of the cylinder, will be removed when the protective sleeve is in place over the wires and the connection between the plug of one wire is made to the receptacle or socket of the other wire. Activation of the adhesive layer can be via a pull strip, the protective layer being frangible and containing an epoxy component which when mixed with the other epoxy component of the adhesive layer will result in a strong epoxy, or another similarly available manner of adhesion with initial protection. Even a BandAid® bandage's piece of removable protective paper to expose the underlying adhesive can be used within the interior of the sleeve.

In embodiments that provide an initial square of rectangular strip, the adhesive covers only the side of the strip intended to become the interior of the sleeve. The adhesive may cover the entire interior surface of the sleeve 10 or it may cover only an essential portion of the surface, such as a center strip. In the preferred embodiment, the adhesive extends to at least two inches from each of the ends of the sleeve 10. The adhesive, when exposed and activated, will attach the cylinder's inside surface to the cords 14 and the electrical/mechanical connection to thereby create a wide and impenetrable seal to keep the elements away from the connection. This serves to protect the electrical/mechanical wire to wire connection from water, dirt, and dust. Because the majority or entirety of the interior of the sleeve will adhere to the cords, the wires adjacent the plug and the socket components and the connection itself, will remain sealed within the sleeve regardless of minor tears or ruptures in the sleeve. In an alternate embodiment, the sleeve is reusable but the interior layer of adhesive and/or the protective and activating layer are replaceable and disposable after each use. The sleeve and its interior adhesive layer should be made with a removable disposable interior cover layer to preserve the adhesive before it is applied. The disposable cover layer for the adhesive may be a plastic or wax paper among other possibilities. In preferred embodiments, the disposable cover includes a tab 20 or other mechanism at one corner or edge of the interior of the sleeve such that the cover can be easily removed during intended application.

At each open end of the hollow cylinder are openings 21 and 23. The overall diameter of the openings and the length of the cylinder from opening 21 to opening 23 is suited to the gauge of the wires being connected and their mechanical/electrical connecting elements (male plug and female socket). Different sizes and lengths are intended to be made by a manufacturer and, yet, a single “one size fits all” may also be made and sold. At the openings 21 and 23, a fold-back seam is made which will contain a drawstring 18, a belt, an elastic band, etc. or other mechanism for tightening and sealing the open ends of the sleeve about the wires. The drawstrings 18 are preferably housed in circumferential pockets on each end of the sleeve 10. The drawstrings 18 have excess string 20 for ease of gripping and manipulation and tying off by a user. Other means for securing the ends are also possible. These alternatives include Velcro ties, elastics, or traditional string ties. The end ties 19 also close off the interior of the cylindrical sleeve from water, dust and debris, providing additional protection against the outdoor elements of the ends and connections of the wires. The end ties 18 may also include an adhesive at the points at which they make contact with the outside surfaces of the wires/cord 14.

The preferred embodiment of the invention is quickly and simply positioned by first threading a first open end of the sleeve over the connecting end of a first wire 14 and then connecting the wire's connection element to the mating connection element of a second wire. Then, the sleeve can be easily positioned with its middle over the mechanical/electrical connection with the second open end of the sleeve passing over the connection and over a length portion of the second wire. The sleeve can slide along the length of the wires until its location is ensured such that the mechanical and electrical connections of the wires (the male plug and the female receptacle or socket) covered by the sleeve with the open ends extending around the wires, adjacent the plug and the socket connection. The drawstrings are then tightened or the openings otherwise cinched or closed (or rubber bands at the ends will hold the same) such that the device is longitudinally located over the wires and the plug/socket connection.

Then, the adhesive layer is activated, either by crushing the sleeve and causing the protective layer to allow the adhesive (or epoxy) to become active, by removing protective cover paper, by pulling on an activating/exposing tab, etc. In one way or another, the protective layer is removed and the adhesive layer exposed and activated for use. Then, the user will gently collapse or crush the side wall of the cylinder, pressing on its outside surface, to have the same generally conform to the surface geometry of the ends of the wires and the mechanical and electrical (male plug to female socket) connection. The sleeve is thus a dually protective, inexpensive protection for the wire connections. One layer of protection is provided by the sleeve, held in place by the adhesive, and the other is a consequence of the ends of the sleeve being tightly held to the wire, adjacent the mechanical and electrical connection—by the drawstrings, the rubber bands, elastic, etc. The device can be removed, as desired, by either using a pair of scissors or, in an alternate embodiment, by pulling on a release tab running along the length of the sleeve, which then exposes the electrical and mechanical connection, allows the user to disengage the same, and allows the user to remove the sleeve.

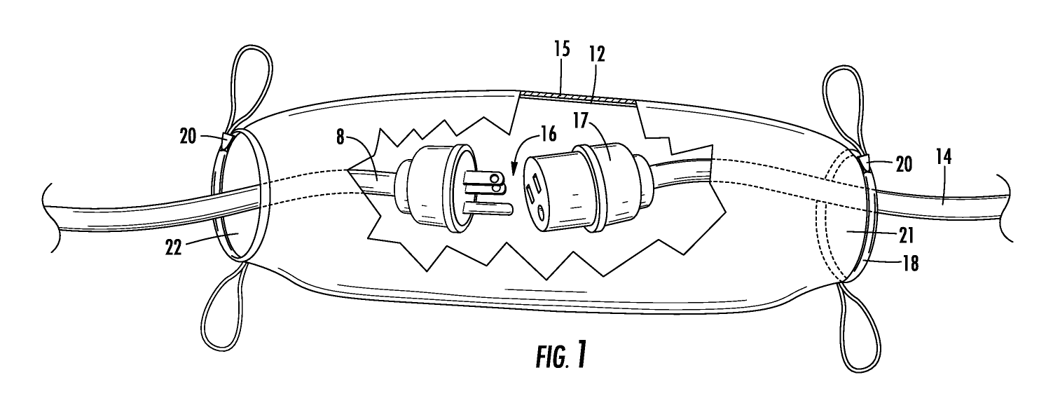

In embodiments intended to cover a connection of two cords as shown in FIG. 1, one open end of the sleeve should be threaded onto one cord first. The cords should then be joined (plug to socket) and the sleeve 10 moved over the connection area 16. Once the sleeve 10 is on top of the desired location the adhesive protection cover on the interior 12 of the sleeve can be removed by pulling the provided tab 20 to expose and/or activate the adhesive. The adhesive is then able to be manually crushed and thus attached to the cords 14 at the desired location by making contact with the cords and the plug and socket ends thereof and preferably applying light collapsing pressure. The user should next even out the surface of the sleeve 10 to remove any air bubbles. Finally a user closes the end ties 18, preferably drawstrings, either by pulling or tightening the end ties, and therefore fully securing the invention at its desired point. The protective cover provided by the invention will protect the cords and their connections, from damage, erosion and exposure. If a user so desires, the invention can be easily removed after use without damage to the cords by merely opening the end ties and undoing the adhesive seal by peeling, cutting, or otherwise removing the sleeve.

What is claimed is:

1. A protective cover for the mechanical and electrical connections of a pair longitudinally connecting wires comprising:
a water resistant cylindrical sleeve extending over said connections and only a portion of the longitudinal length of said wires, said sleeve being provided with a pair of opposed ends and an adhesive interior surface.

2. A protective cover as claimed in claim 1 wherein said sleeve further comprises a cinching and fastening mechanism at each of said pair of opposed ends.

3. A protective covering as claimed in claim 1 wherein said fastening mechanism is a pair of drawstrings

4. A protective covering as claimed in claim 1 further comprising a removable, protective surface layer initially covering over said adhesive interior surface.

5. A protective covering as claimed in claim 3 wherein said protective surface includes an pull tab for exposing and activating said adhesive interior surface.

6. A protective covering as claimed in claim 1 wherein said adhesive interior surface extends at least two inches from each end of the sleeve.

7. A protective covering as claimed in claim 1 wherein said sleeve is crushable to conform to the general shape of the mechanical and electrical connections of said wires.

8. A protective covering as claimed in claim 1 wherein said opposed ends of said sleeve are secured to said wires by rubber bands held in fold-over circumferential pockets.

9. A protective covering as claimed in claim 3 wherein said adhesive interior surface comprises a first epoxy component and said protective surface layer comprises a second epoxy component which when mixed with said first epoxy component creates an adhesive layer.

10. A protective covering as claimed in claim 1 wherein said sleeve is provided with a removal mechanism passing through the surface of said sleeve and having a gripping tab which facilitates selective removal of said sleeve from said wires.

11. A protective covering as claimed in claim 1 wherein said sleeve is of a length to extend from a first of said pair of wires, over said mechanical and electrical connection to the second of said pair of wires.

12. A protective covering as claimed in claim 10 wherein said sleeve extends only about 2 inches beyond said mechanical and electrical connection of said pair of wires.

13. A protective covering as claimed in claim 1 wherein said sleeve is of a length and said openings of a circumference corresponding to the gauge of said pair of wires and said mechanical and electrical connection.

14. A protective covering as claimed in claim 1 wherein said sleeve is crushable and collapsible around said mechanical and electrical connection of said pair of wires without negatively impacting on the integrity of said sleeve to protect the same from water.
